(19) United States
(12) Patent Application Publication
(10) Pub. No.: US 2008/0294406 A1
(43) Pub. Date: Nov. 27, 2008

(54) CONTEXT-BASED COMPLETION FOR LIFE SCIENCE APPLICATIONS

(75) Inventor: Damon Hachmeister, North Grafton, MA (US)

Correspondence Address: LOWRIE, LANDO & ANASTASI, LLP, ONE MAIN STREET, SUITE 1100, CAMBRIDGE, MA, 02142, US

(73) Assignee: THE MATHWORKS, INC., Natick, MA (US)

(21) Appl. No.: 12/051,946

(22) Filed: Mar. 20, 2008

Related U.S. Application Data
(63) Continuation-in-part of application No. 11/891,143, filed on Aug. 8, 2007.
(60) Provisional application No. 60/931,041, filed on May 21, 2007.

(51) Int. Cl. G06G 7/48

(52) U.S. Cl. 703/11

(57) ABSTRACT

A system is provided that can include storage logic to store a data structure that includes an identifier. The storage logic may also store an object associated with the identifier, where the identifier may include a value, unit information, or a context. The storage logic may further store a result. The system may include processing logic to process an expression to determine whether the identifier is compatible with the expression, the determining performed using the value, the unit information, or the context. The processing logic may insert the identifier into the expression when the identifier is compatible with the expression, the inserting based on a user action. The processing logic may execute the expression on behalf of a life sciences model, may generate the result based on the executing, and may provide the result to the storage logic.

### RELATED APPLICATIONS

This application is a continuation-in-part application of U.S. pending patent application Ser. No. 11/891,143, filed Aug. 8, 2007, which claims the benefit of provisional patent application No. 60/931,041, filed May 21, 2007, the contents of these applications are incorporated herein by reference in their respective entireties.

### BACKGROUND INFORMATION

People working in life sciences disciplines, such as biology, genetics, chemistry, zoology, medicine, etc., may wish to simulate interactions among living organisms (e.g., cells) to obtain information about these organisms. For example, interactions between living organisms may be simulated to support research activities, analyze data, instruct students, etc. Information gained from these simulations may help these scientists further their understandings of the simulated organisms.

People working in life sciences disciplines may not have strong mathematical, programming, and/or engineering backgrounds; therefore, they may be disinclined to make use of computer-aided modeling and/or analysis when attempting to simulate living organisms, even though computer-aided modeling and/or analysis may be useful for simulating living organisms.

One reason that people working in the life sciences may be reluctant to use simulation software may be because simulation software does not allow them to represent equations using notations familiar in the life sciences. For example, people in the life sciences may typically represent equations using symbols for variables, arrows to show reaction directions, and/or icons to represent cells, species, etc. Interacting with simulation software may require that these people convert information from a familiar representation into a different representation that is specific to a computer application. In some situations, this different representation may be unfamiliar or unintuitive.

By way of example, a scientist may wish to simulate a biological system, where a biological system is a system that can include anything that has a biological origin (e.g., elements containing carbon). A computer application that may be available to the scientist may require that inputs for a simulation of the biological system be provided as text-based differential equations, where this type of representation is not common in the life sciences. The scientist may find that converting common life sciences representations into differential equations for the computing application may be difficult and/or time consuming. These difficulties may discourage the scientist from taking advantage of computer-based simulations even though using a computer may make simulation activities faster and/or more accurate.

### SUMMARY

In accordance with an embodiment, one or more computer-readable media storing instructions executable by processing logic is provided. The media may store one or more instructions for processing an expression for use as an input to a life sciences model, the expression including one or more symbols and one or more operators. The media may further store one or more instructions for interacting with a data structure that includes a plurality of symbols with at least one of the plurality of symbols related to a software object that includes a value, a context, or unit information. The media may also store one or more instructions for identifying the at least one symbol as a compatible symbol that can be used with the expression and one or more instructions for displaying the compatible symbol proximate to the expression. The media may store one or more instructions for receiving a user input that indicates that the compatible symbol should be inserted into the expression at a predetermined location and one or more instructions for inserting the compatible symbol into the expression proximate to the predetermined location. The media may further store one or more instructions for executing the life sciences model using the expression when the expression includes the compatible symbol and one or more instructions for generating a result for the life sciences model based on the executing.

In accordance with another embodiment, a computer-implemented method is provided. The method may interact with a life sciences model using at least a first symbol, an operator, the first symbol and the operator, the first symbol and a second symbol; or the first symbol, the second symbol, and the operator. The method may further include displaying a compatible symbol proximate to an executable expression that includes the first symbol, the second symbol or the operator. The compatible symbol may be retrieved from a data structure that stores the compatible symbol and a plurality of other symbols. The compatible symbol may be associated with a software object that includes at least one of a value, a context, or unit information for the compatible symbol. The method may also include selecting the compatible symbol, the selecting inserting the compatible symbol at a predetermined location in the expression. The method may include executing the expression using the life sciences model and generating a result based on the executing.

In accordance with another embodiment, one or more computer-readable media storing instructions executable by processing logic may be provided. The media may store one or more instructions for receiving a first user input associated with a context. The media may store one or more instructions for querying a symbol table comprising a plurality of symbols and a plurality of operators, the plurality of symbols including a compatible symbol, and the plurality of operators including a compatible operator. The media may also store one or more instructions for interacting with a rule, the rule used to identify the compatible symbol included in the plurality of symbols or the compatible operator included in the plurality of operators, the compatible symbol associated with a software object that includes information used within the context. The media may further store one or more instructions for inserting the compatible symbol or the compatible operator into an executable expression that includes the user input, the inserting based on a second user input configured to associate the compatible symbol or the compatible operator with the executable expression, the executable expression producing a result when executed in a model.

In accordance with still another embodiment, a system is provided. The system may include storage logic to store a symbol table comprising an identifier. The storage logic may also store an object associated with the identifier, where the identifier may include a value, unit information, or a context. The storage logic may further store a result. The system may include processing logic to process an expression to determine whether the identifier is compatible with the expression, the determining performed using the value, the unit information, or the context. The processing logic may insert the identifier into the expression when the identifier is compatible with the expression, the inserting based on a single user action. The processing logic may execute the expression on behalf of a life sciences model, may generate the result based on the executing, and may provide the result to the storage logic.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 illustrates an exemplary system that can be configured to practice an exemplary embodiment;

FIGS. 2A and 2B illustrate exemplary contexts that can be used in a model;

FIGS. 3A and 3B illustrate an exemplary arrangement for contexts used in a model;

FIG. 3C illustrates an exemplary arrangement of contexts that can support moving a symbol from one context to another context;

FIG. 4 illustrates an exemplary interaction between a model, expressions used in the model, and a symbol table;

FIGS. 5A and 5B illustrate exemplary configurations for symbol tables that can be used with a model;

FIG. 6A illustrates an exemplary configuration for storing information used in a model in a symbol table and a software object;

FIG. 6B illustrates an exemplary configuration for storing information used in a model in a symbol table that includes a software object;

FIG. 7 illustrates a rule table that can be used with a symbol table to provide auto-complete entries for a model;

FIGS. 8A to 8C illustrate examples of auto-complete entries that can be provided to a model;

FIG. 9 illustrates a functional diagram that includes logic that can be used to implement an exemplary embodiment; and

FIGS. 10A to 10C illustrate exemplary processing for auto-completing entries for a model.

### DETAILED DESCRIPTION

The following detailed description of implementations consistent with principles of the invention refers to the accompanying drawings. The same reference numbers in different drawings may identify the same or similar elements. Also, the following detailed description does not limit the invention. Instead, the scope of the invention is defined by the appended claims and their equivalents.

### Introduction

Known computer simulation applications may not be readily useable by persons skilled in the life sciences (e.g., biologists, zoologists, geneticists, chemists, medical researchers, etc.) because these people may not have strong programming or scientific computing backgrounds. As a result, computer-based simulation may not be used to its fullest potential by persons working in the life sciences.

An illustrative embodiment may help people in the life sciences by allowing them to simulate biological systems using an interactive modeling environment that may not require specialized programming skills. The embodiment may receive information from a user in a format that is consistent with formats commonly used within life science disciplines. For example, the embodiment may allow a user to enter reactions, species, rules, compartments, etc., using graphical representations and/or textual representations that are consistent with and similar to representations used in a field in which the user is familiar (e.g., biology). The embodiment may further allow the user to connect species, reactions, etc., using familiar notations, such as lines that can include arrows.

The illustrative embodiment may further help people in the life sciences by allowing them to complete expressions without having to manually type in the entire expression. For example, the embodiment may parse user inputs to determine when enough information has been entered to allow the embodiment to suggest one or more terms (e.g., variable names or operators) that can be used to complete the expression. The embodiment may process the user inputs to determine if stored entries (e.g., variables) can be used in the expression. By way of example, a user may begin entering an expression that can be executed by a biological model. The expression may be for a reaction that includes a rate variable a that has units of feet. The user may enter an operator, such as + following a. The embodiment may evaluate a, units associated with a, and operators used with a, namely +, and may suggest other symbols (e.g., variable names) and/or operators that can be used with a to form an expression that can be evaluated to produce a result.

For example, a workspace may hold a data structure, such as a symbol table, that includes symbols that can be used in expressions for the model. In this example, the symbol table may include symbol b that has units of feet and symbol c that has units of pounds. Since a is being added to something in this expression, only b makes sense since it has units that match the units of a, namely feet. The embodiment may display b after the + sign. The user may depress a key, such as a tab key to insert the suggested symbol into the executable expression. The completed expression may be executed during simulation of the model to produce a result, such as a plot that can be displayed to the user.

In some situations multiple entries in the symbol table may be appropriate for use in the expression. For example, the symbol table used above may include variables a, z, k, and y each having units of feet. In these situations, the embodiment may rank appropriate symbols according to determined criteria and may display one or more symbols to the user via an ordered listing so that the user can select one of the list members by depressing a key or issuing another type of command (e.g., an utterance). Criteria that can be used to order appropriate symbols can be based on other expressions used in the model, types of symbols stored in the symbol table, a user's past activities with the current model or with another model, activities performed by persons affiliated with the user (e.g., co-workers), etc.

### Exemplary System

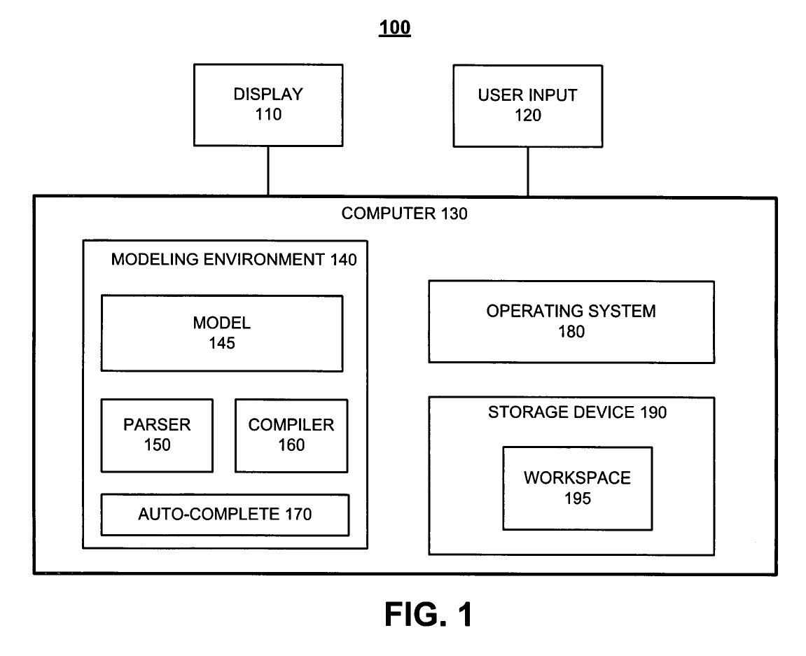

FIG. 1 illustrates an exemplary system 100 that can be configured to practice an exemplary embodiment. System 100 may include display 110, user input 120, computer 130, modeling environment 140, model 145, parser 150, compiler 160, auto-complete 170, operating system 180, storage 190, and workspace 195. The embodiment of FIG. 1 and/or embodiments shown in other figures are exemplary and alternative embodiments may include more devices, fewer devices, and/or devices in arrangements other than the arrangements shown in the figures (e.g., distributed arrangements).

Display 110 may include a device that provides information to a user. Display 110 may include, for example, a cathode ray tub (CRT) display device, a liquid crystal display (LCD) device, a plasma display device, a projection display device, etc. In an embodiment, display 110 may include a graphical user interface (GUI) that displays information to a user.

User input 120 may allow a user to interact with computer 130. For example, user input 120 may receive input from a keyboard, a mouse, a trackball, a microphone, a biometric input device, a touch sensitive display device, etc.

Computer 130 may include a device that performs processing operations, display operations, communication operations, etc. For example, computer 130 may include a desktop computer, a laptop computer, a client, a server, a mainframe, a personal digital assistant (PDA), a web-enabled cellular telephone, a smart phone, smart sensor/actuator, or another computation or communication device that executes instructions to perform one or more activities and/or generate one or more results. Computer 130 may include one or more processing devices that can be used to perform processing activities on behalf of a user.

Computer 130 may further perform communication operations by sending data to or receiving data from another device, such as a server. Data may refer to any type of machine-readable information having substantially any format that may be adapted for use in one or more networks and/or with one or more devices. Data may include digital information or analog information. Data may further be packetized and/or non-packetized.

Modeling environment 140 may include logic that lets a user model biological components and/or systems. Modeling environment 140 may further let the user model other types of components and/or systems, such as physical systems, event driven systems, etc. Modeling environment 140 may include text-based, graphical, and/or hybrid (e.g., a combination of text-based and graphical) user input and/or display interfaces to facilitate user interactions with a model. In an embodiment, modeling environment 140 may be implemented in a dynamically typed programming language.

In one embodiment, modeling environment 140 may include model 145, parser 150, compiler 160, and auto-complete 170. Model 145 may include an executable model of a biological component/system and/or of another type of component/system. In an embodiment, model 145 may be configured to display information to a user in a format used in a discipline in which the user has experience (e.g., biology). For example, a user working in a biological field may be familiar with representing reactions using graphical symbols and arrows to show the direction of reactions. Model 145 may let the user enter information via graphical symbols, lines, arrows, and/or other techniques familiar to the user so that the user does not have to be familiar with computer programming techniques, such as object oriented programming techniques. Model 145 may further include executable instructions that allow the model to be executed on behalf of the user. Model 145 may produce a result for the user when model 145 is executed.

Parser 150 may include logic that runs when a user is interacting with model 145. Parser 150 may include a listener that identifies when a user input is present. Parser 150 may identify logical and/or mathematical completions for expressions entered by a user while the user is interacting with model 145. Parser 150 may further determine when enough information is present to allow parser 150 to associate a meaning with the user input. For example, a user may enter a which has units of meters. Parser 150 may determine that having only meters to operate on does not allow any meaning to be associated with the user input.

For example, meters may be added to a length, multiplied by a weight, divided by a mass, etc. The user may then enter + and parser 150 may determine that meters and + can be used to associate a meaning to another term that can be used in the expression. For example, parser 150 may determine that the next entry needs to be a length, such as a length specified in meters, centimeters, millimeters, etc. Continuing with the above example, parser 150 can interact with other logic in computer 130 to identify symbols (e.g., variables) that have units of meters. For example, parser 150 can interact with lookup logic (not shown) and/or auto-complete 170 to identify stored symbols that can be used to auto-complete a portion of the expression or the entire expression.

Compiler 160 may include logic that compiles and/or executes model 145. In one embodiment, compiler 160 may maintain model 145 in a compiled state while a user interacts with model 145. The compiled state may allow model 145 to determine whether user inputs are syntactically correct while the user is entering information into model 145. For example, compiler 160 may determine whether two values, entered by a user, can be added together to provide a meaningful result. Compiler 160 may generate an error when it determines that incompatible information has been entered by the user. In one embodiment, compiler 160 may operate with a debugging application to diagnose errors for the user and/or to suggest corrections to the user.

Auto-complete 170 may include logic that completes strings, expressions, etc., on behalf of a user while the user is interacting with model 145. Auto-complete 170 may complete a portion of a string, expression, etc., or auto-complete 170 may complete an entire string, expression, etc. For example, a user may be working with an expression and may have entered

a*b

In this example, valid auto-complete entries may include 2 to form b2 in the expression and/or 2+3c=D to form a complete expression of

a*b2+3c=D

Auto-complete 170 may allow the user to insert b2 and/or 2+3c=D in by performing a single action, such as by depressing a single key.

Auto-complete 170 may operate with parser 150 and/or other logic in system 100 to identify a symbol or an operator entered by the user. Auto-complete 170 may determine whether stored information, such as symbols, variable names, operators, etc., can be used to complete an entry (e.g., an expression) on behalf of the user. These identified symbols, etc., may be suggested to the user for use in the expression.

In some situations, auto-complete 170 may determine that more than one stored symbol may be appropriate for use in an expression. In these situations, auto-complete 170 may order (e.g., rank) appropriate symbols according to one or more criteria, such as rules. Rules may be used to rank appropriate symbols based on unit information (e.g., feet, meters, seconds, etc.) for the symbols, or based on symbols used elsewhere in model 145.

Operating system 180 may include logic that manages hardware and/or software resources associated with computer 130. For example, operating system 180 may manage tasks associated with receiving user inputs via user input 120, initiating modeling environment 140, allocating memory, prioritizing system requests, etc. In an embodiment, operating system 180 may be a virtual operating system.

Storage 190 may include logic that stores information in computer 130. Storage 190 may be dynamic (e.g., random access memory) and/or static storage (e.g., a hard disk). For example, storage 190 may store model 145, symbols, user identifiers, etc. In an embodiment, storage 190 may include a workspace 195 that stores information used in expressions for model 145.

Workspace 195 can include logic that can store variable names, data associated with variables, strings, addresses, software objects, etc., that are used in model 145. Embodiments of workspace 195 may bind variables to portions of model 145. For example, workspace 195 may include two variables having the same name but different values, for example, b=2 and b=10. In this example, variable b having a value of 2 may be used in a first subsystem (subsystem 1) and the variable b having a value of 10 may be used in a second subsystem (subsystem 2) of model 145. Workspace 195 may bind b=2 to subsystem 1 and variable b=2 to subsystem 2 to avoid conflicts between the two variables having the same name.

### Exemplary Context

In an embodiment, model 145 may consist of one or more sections or parts. In one embodiment, the model sections can be referred to as contexts, where a context is a portion of model 145 that includes information (e.g., model components) unique to that context (or portion).

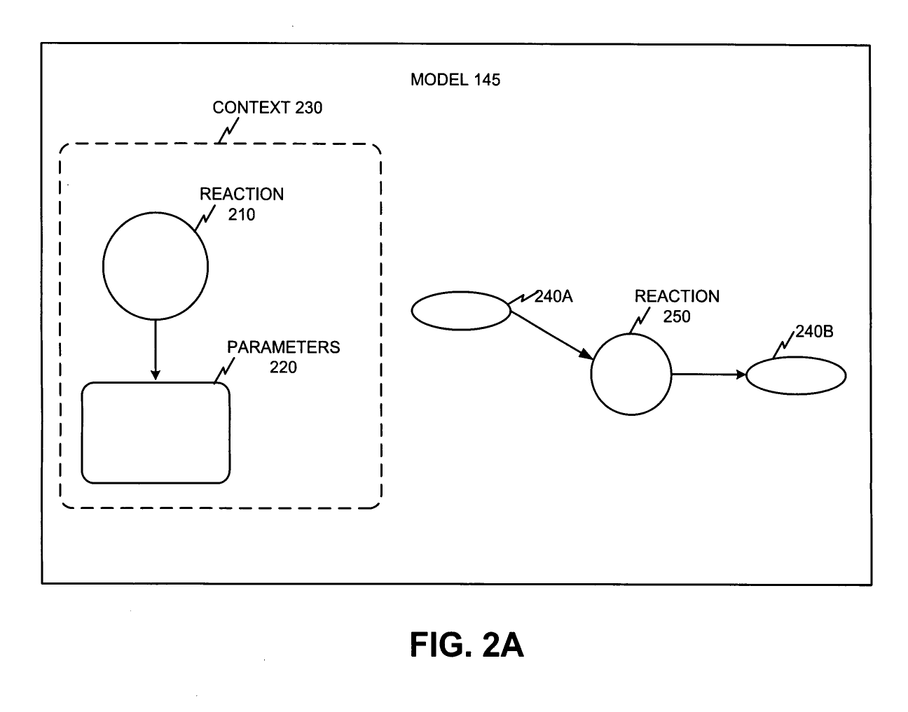

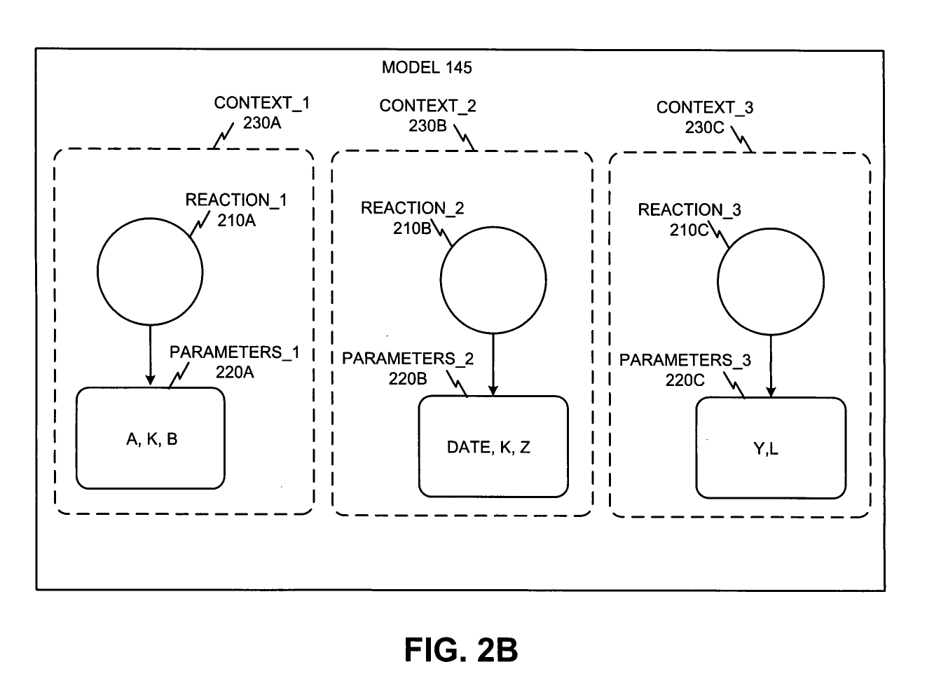

FIG. 2A illustrates a context 230 that can be used in model 145. The embodiment of FIG. 2A can include model 145, context 230, species 240A and 240B and reaction 250. Context 230 may represent a portion of model 145 that can include items, such as components, reactions, parameters, etc., that can be used to simulate the portion of model 145 contained within context 230. In the embodiment of FIG. 2A, context 230 can include reaction 210 and parameters 220.

Reaction 210 may include information that identifies or describes a transformation, transport, degradation (e.g., a→null), generation (e.g., null→a), and/or binding process that can change one or more species associated with model 145. For example, a reaction may change the amount of a species in model 145. In an embodiment, a reaction may be represented using a nomenclature, such as,

species_{—}1+species_{—}2<−>species_{—}3.

Exemplary embodiments of reaction 210 may include reaction rate equations, laws (e.g., kinetic laws), etc. Reactions may be associated with a context (e.g., reaction 210 in context 230) or reactions may not be associated with a context (e.g., reaction 250).

Parameters 220 may include information that can be used with reactions, species, and/or other components of model 145. Parameters 220 can include variables, constants, etc., in model 145.

Model 145 can include information that is not included in context 230, such as species 240A and 240B (collectively species 240) and reaction 250. Species 240 may be a chemical or an entity that participates in a reaction within model 145. For example, species 240A may interact with reaction 250 to produce species 240B. Exemplary species may include, but are not limited to, deoxyribonucleic acid (DNA), adenosine triphosphate (ATP), creatine, G-Protein, mitogen-activated protein kinase (MAPK). An embodiment of species 240 may have an amount that includes units in model 145 and that amount may remain constant or may change during simulation of model 145 (e.g., via iterative simulations of model 145).

In the embodiment of FIG. 2A, items included within context 230 may be defined only within that context. For example, reaction 210 may use parameters 220, where parameters 220 are known only in context 230. If reaction 250 attempts to use a parameter included in parameters 220, that parameter may not be recognized with respect to reaction 250 since reaction 250 is outside context 230.

FIG. 2B illustrates an embodiment of model 145 that includes three contexts, namely context_1 230A and context_2 230B, and context_3 230C. Context_1 230A may include reaction_1 210A and parameters_1 220A; context_2 230B may include reaction_2 210B and parameters_2 220B; and context_3 230C may include reaction_3 210C and parameters_3 220C.

Parameters_1 220A may include symbols A, K, and B and these symbols may be defined only within context_1 230A and may work only with reaction_1 210A.

Parameters_2 220B may include symbols DATE, K, and Z, where these symbols are defined only within context_2 230B and may work only with reaction_2 210B.

Parameters_3 220C may include symbols Y and L, where these symbols are defined only within context_2 230C and may work only with reaction_3 210C.

By way of example, referring to FIG. 2B, assume a user is working with context_1 230A. Further assume that A has units of feet, and K has units of pounds in context_1 230A. Also assume that for context_2 230B K has units of inches. The user may type

A*

at a prompt, such as a command line prompt. Since the user is working in context_1 230A, auto-complete 170 may determine that K having units of pounds is an appropriate symbol to complete the expression entered by the user since foot-pounds may be an acceptable representation of units for model 145. Auto-complete 170 may display K from parameters_1 220A because auto-complete 170 knows to suggest only appropriate symbols for the context in which the user is working, even though K having units of inches in parameters_2 220B may possibly be used with A * to produce a meaningful result. In this example, K in parameters_2 220B may not be shown to the user since it is not included in context_1 230A.

### Exemplary Model Relationships

Model 145 may include information that can be arranged based on relationships. For example, model 145 can be thought of as global container, or context, that holds a number of sub-system like entities (e.g., contexts) that in turn each hold one or more individual components or smaller sub-systems (or sub-contexts). These sub-system like entities and/or individual components can have relationships with model 145 and among each other. Information making up model 145 can be arranged in a hierarchy with model 145 acting as a root of the hierarchy. Reactions, species, compartments, etc., within model 145 can act as local contexts that can include child contexts or other information such as variables, operators, etc.

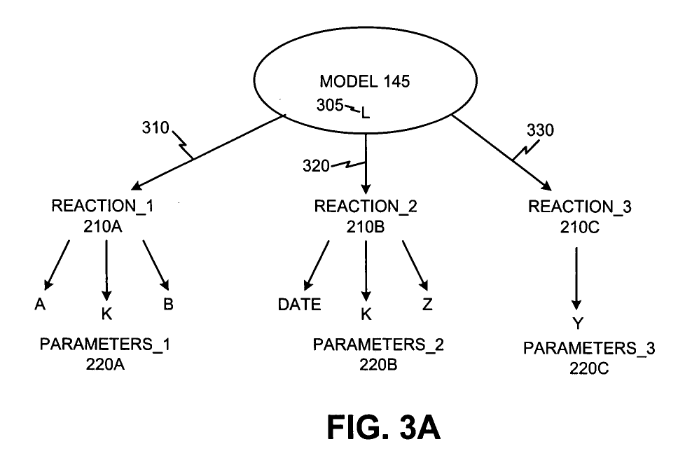

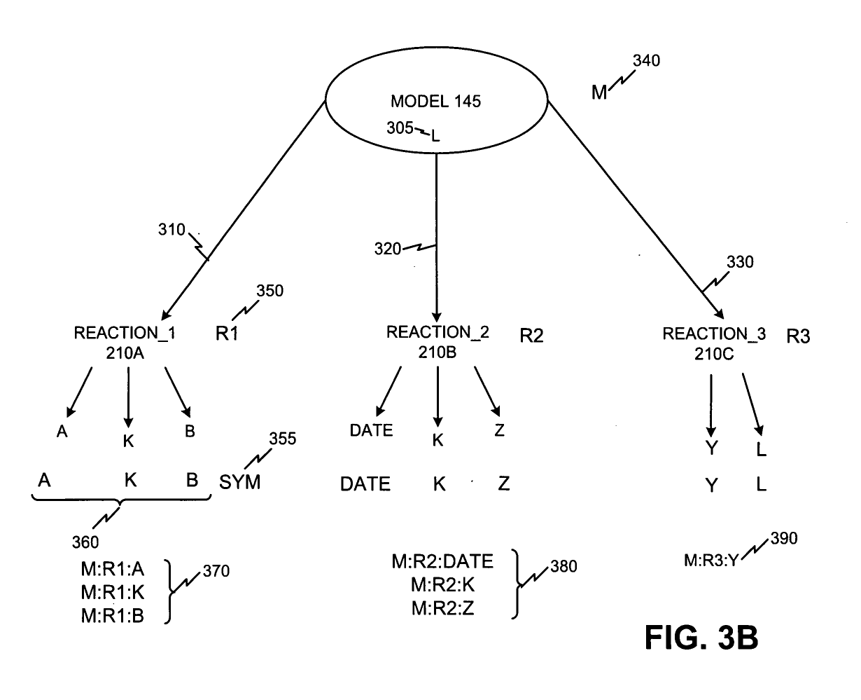

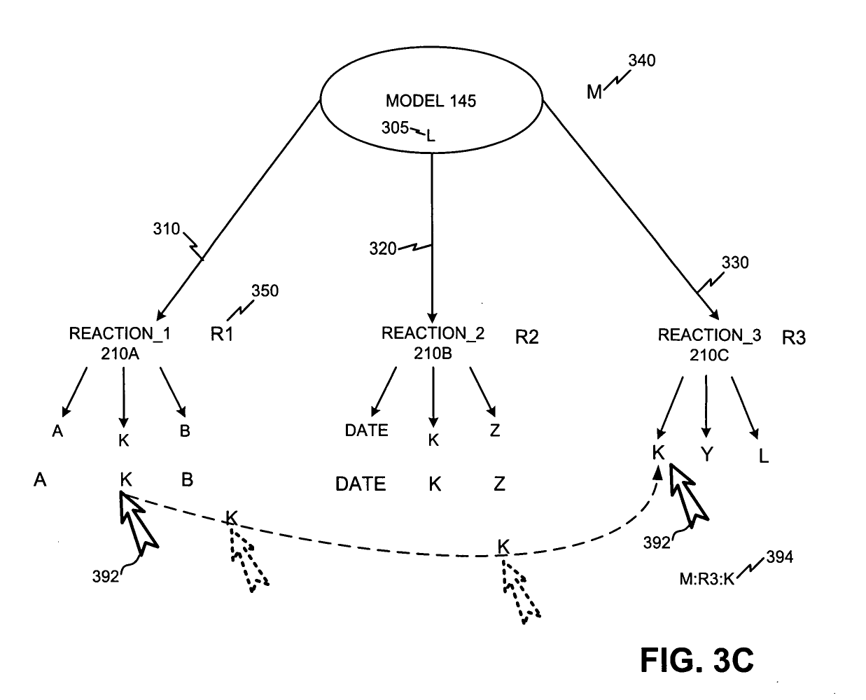

FIG. 3A illustrates an exemplary relationship for information in model 145. In FIG. 3A, model 145 may include a variable L 305. In the example of FIG. 3A, model 145 may be a global context and L 305 may be included in the global context. Model 145 may include reaction_1 210A, reaction_2 210B, and reaction_3 210C, where reactions 210A, 210B, and 210C can be considered as children of model 145. In the embodiment of FIG. 3A, child-contexts (reaction 210A, B and C) can have logical connections 310, 320, and 330 with a parent context, such as model 145. In one embodiment, logical connections 310, 320, and 330 may be links or pointers.

Reactions 210A, 210B, and 210C may each include information, such as parameters. In the example of FIG. 3A, reaction 210A may include parameters_1 220A that can include A, K, and B; reaction 210B may include parameters_2 220B that can include DATE, K, and Z; and reaction 210C may include parameters_3 220C that can include Y and L. Parameters associated with reactions 210A, 210B and 210C may have units associated with them or they may be dimensionless.

In FIG. 3A, contexts may be determined based on location within model 145. For example, reaction_1 210A may be in a first context, reaction_2 210B may be in a second context, and reaction_3 210C may be in a third context. In other embodiments, contexts can be based on other things, such as a user's identity, a network address from which a user is working, permissions, time (e.g., a context worked on first may be a parent to a context worked on at a later time/date), etc.

In FIG. 3A, a child context may inherit information from a parent context. For example, reactions 210A, 210B and 210C may be child contexts with respect to a context for model 145. These child contexts may each have access to L 305 because L 305 is associated with a context that is superior to contexts that include reactions 210A, 210B and 210C. In FIG. 3A, child contexts may not be able to exchange information with each other. For example, reaction_1 210A may not be able to access parameters 220B for reaction_2 210B because reaction_2 210B is not superior or inferior to reaction_1 210A.

Embodiments of system 100 can use certain syntaxes to represent information in model 145. For example, models, reactions, symbols, etc. can be represented using specified syntaxes that can include characters, numbers, symbols, etc. These specified syntaxes may identify relationships among contexts in model 145.

FIG. 3B illustrates an exemplary technique for representing information in model 145. A user may interact with system 100 to configure model 145. System 100 may represent relationships between model 145, reactions 210A, 210B and 210C, and/or parameters 220A, 220B and 220C using specified notations. For example, system 100 may use special characters, such as colons (:), semicolons (;), underscores (_), dashes (-), at signs (@), percent signs (%), etc., to identify relationships between model 145 and other information in the model.

Assume that a user is interacting with model 145 at a command line prompt in a graphical user interface (GUI). The user may be entering information for a reaction. In this example, the user may be working in a context that includes reaction_1 210A. The user may enter A at the command line prompt. System 100 may determine that A 360 is associated with reaction_1 210A and with model 145 since reaction_1 210A is included in model 145. System 100 may represent A 360 and its relationship to a reaction and/or model using a syntax, such as model:reaction:symbol.

In FIG. 3B, model 145 may be identified via model identifier M 340; reaction_1 210A may be identified via a reaction identifier R1 350; a parameter used in a reaction (e.g., A 360) may be identified via a symbol identifier SYM 355. Continuing with the above example, A 360 may be represented in system 100 using a format such as model:context:parameter. In one embodiment the format can be represented as M:R1:SYM or as M:R1:A (370 in FIG. 3B). This representation may be internal to system 100 (e.g., may not be visible to a user) or this representation may be visible to a user depending on a configuration of system 100. Other parameters in reaction_1 210A may be represented using similar syntaxes. For example, K 361 can be represented as M:R1:K, and B 362 can be represented as M:R1:B.

In FIG. 3B, information used in other model contexts may be represented as M:R2:DATE 380 for the symbol DATE used in reaction_2 220B or M:R3:Y (390 in FIG. 3B) for the symbol Y used in reaction_3 220C. Other embodiments may allow external models to be associated with reactions, symbols, etc., using syntaxes that are similar to those of FIG. 3B. In still other embodiments, syntaxes that differ from those of FIG. 3B may be used to express relationships between pieces of information in one or more models.

Information in contexts within model 145 may be scoped to the context that includes the information. For example, L in reaction_3 210C may be tightly scoped to reaction_3 210C such that typing L while working on reaction_3 210C may use L that is in reaction_3 210C rather than L 305 that resides in model 145. If a user working in reaction_3 210C wants to use L 305, the user may need to use a syntax like M:L to override the default scoping of model 145.

FIG. 3C illustrates an embodiment in which a symbol can be moved among contexts in a model. In FIG. 3C, symbol K in one context (reaction_1 210A) may be moved to another context, such as reaction_3 220C. A user may select K via cursor 392 and may drag K from reaction_1 220A to reaction_3 220C. The user may place K into reaction_3 220C. In an embodiment, a copy of K can be placed in reaction_3 210C, and in still another embodiment, K can be transferred from reaction_1 210A to reaction_3 210C.

Embodiments may allow units of K to be inferred when K is moved from one context to another. For example, K may have units of meters in reaction_1 210A and may be used in an expression such as K+B in reaction_1 210A, where B is also in meters. In contrast, reaction_3 210C may include Y and L both having units of feet. When K is moved from reaction_1 210A to reaction_210C, K may be converted from meters to feet. In this example, the units of feet are inferred when K is moved into reaction_3 210C. A syntax, such as M:R3:K 394 may be used to represent the association of K with reaction_3 210C once K is moved from reaction_1 210A to reaction_3 210C.

### Exemplary Symbol Table Interaction

Exemplary embodiments of system 100 may perform dimensional analysis to determine whether an auto-complete operation can be performed. Dimensional analysis can determine whether dimensions associated with symbols are compatible so as to make an expression containing the symbol valid. For example, dimensional analysis may determine that the expression A (ft)+B (ft)=C is valid when values for A and B are known since the result of A and B will be in feet (ft). In contrast, dimensional analysis may determine that an error exists when A (ft)+B (ml)=C is entered by a user because feet (ft) and milliliters (ml) do not produce a meaningful quantity when added together. Using the two example expressions above, system 100 may allow B (ft) to be shown to a user as a valid auto-complete entry when A (ft)+has been entered by the user. In contrast, system 100 may not show B (ml) to the user as a valid auto-complete entry because units of ml cannot be added to units of feet to produce a meaningful result.

System 100 may perform dimensional analysis in substantially real-time by maintaining model 145 in a compiled state while a user interacts with the model. For example, model 145 may be maintained in a compiled state using compiler 160 while the user is entering symbols and/or operators into model 145.

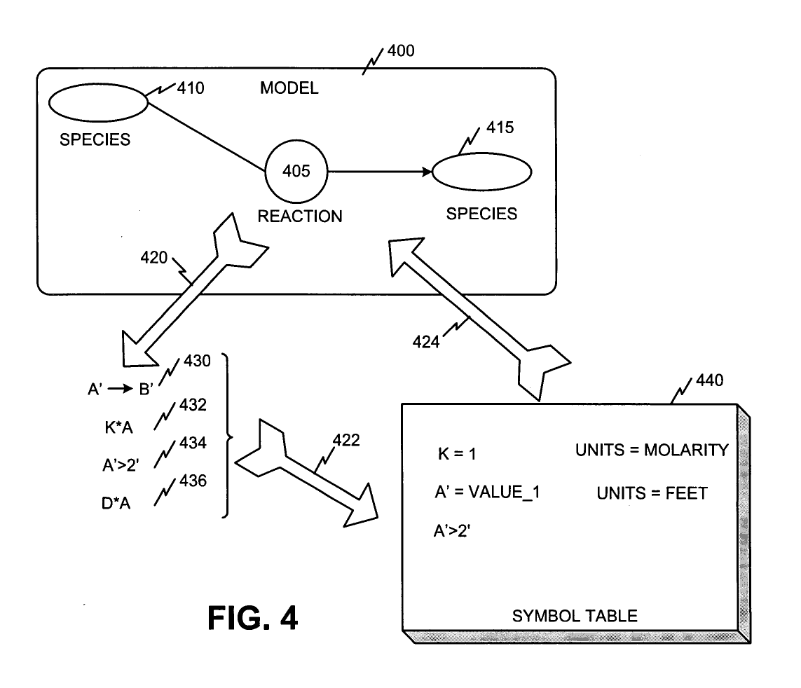

FIG. 4 illustrates a technique that can use a symbol table when performing dimensional analysis on symbols included in a model. In FIG. 4, model 400 may include species 410, species 415 and a reaction 405. For example, species 410 may undergo a reaction and may produce species 415. A user may enter information into model 400 for species 410, reaction 405, and/or species 415. In one embodiment, the user may drag species 410, reaction 405, and species 415 into model 400 from a library, palette, etc.

A user may configure model 400 by entering information for reaction 405. For example, a user may enter a reaction expression 430, a reaction rate 432, a value 434 (e.g., a value for A), and a second reaction rate 436. Information for reaction 405 may be parsed by parser 150 and sent to auto-complete 170. Auto-complete 170 may query symbol table 440 to determine whether information associated with reaction expression 430, reaction rate 432, value 434, or second reaction rate 436 is defined for model 400.

Symbol table 440 may be a data structure that can hold information used in model 400, such as symbols, values, relationships, units, etc., for information used in model 400. Auto-complete 170 may query the data structure to determine whether stored symbols, values, units, relationships, etc., are compatible with the information entered by the user and the dimensionality of the expression. Symbol table 440 may be stored in storage device 190, such as in workspace 195, in an embodiment.

When auto-complete 170 determines that information in symbol table 440 is compatible with the user expression, one or more symbols may be displayed to the user for use in the expression. Symbols displayed to the user may be symbols that are dimensionally consistent with the expression and that can be used with a context that the expression is associated with in model 400.

In an embodiment, the contents of symbol table 440 may be dynamically updated as the user continues to enter additional information into model 400. Updating symbol table 440 may ensure that the contents of symbol table 440 reflect a current status of model 400.

Interactions between model 400, reaction 430, reaction rate 432, value 434, second reaction rate 436, and symbol table 440, as shown by arrows 420, 422 and 424, may iterate continuously while a user interacts with model 400. These continuous iterations may ensure that information in model 400 is continuously evaluated so that auto-complete entries provided to the user are up-to-date.

### Exemplary Symbol Table

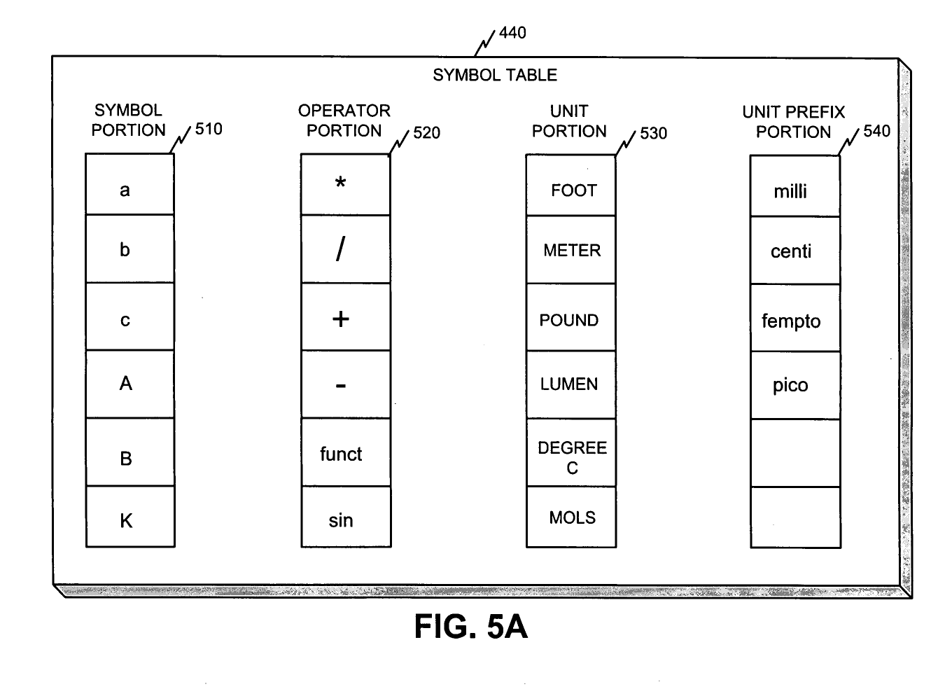

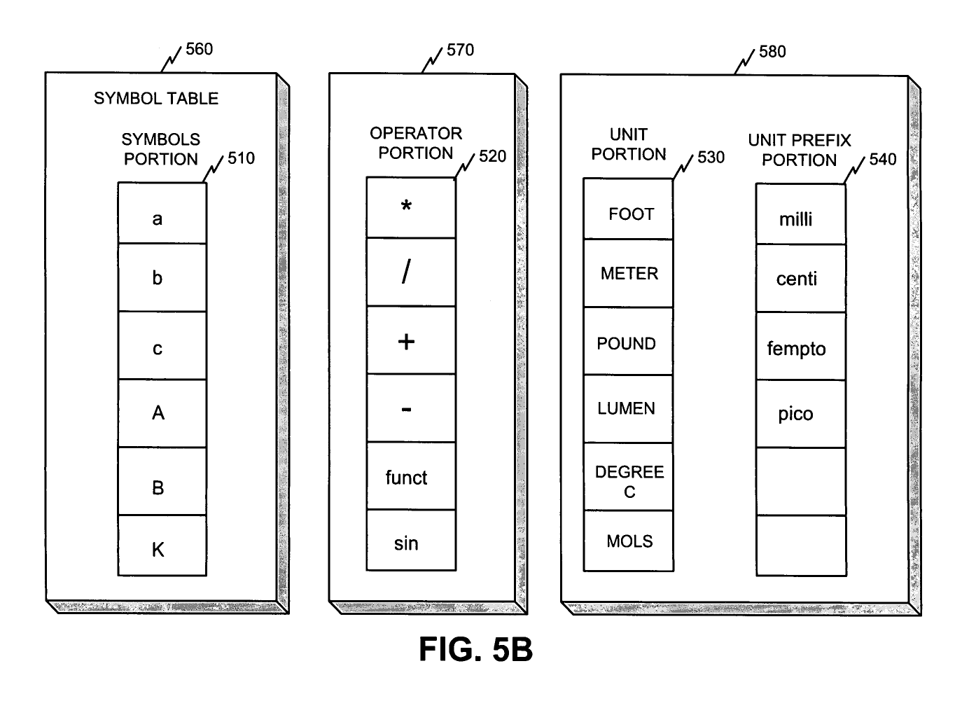

Symbol table 440 may be configured in a number of ways when working with a model. For example, FIG. 5A illustrates an exemplary configuration of symbol table 440 that can be used in an illustrative embodiment of model 400.

In FIG. 5A, symbol table 440 may include symbol portion 510, operator portion 520, unit portion 530, and unit prefix portion 540. Symbol portion 510 may include symbols available to model 400 and/or symbols currently in use by model 400. Operator portion 520 may include operators that can be used with symbols to form expressions. Operators can include +, *, /; functions like sine, cosine, etc.; user defined functions; and/or other types of operators.

Unit portion 530 can include system defined and/or user defined units that can be used with symbols. For example, A may have units of lumen when A is used to represent a luminous flux, such as might occur when A is used in an optical reaction. Unit prefix portion 540 may include user defined or system defined information that can be used as a prefix to an entry in unit portion 530. For example, a unit of meter may be preceded with milli from unit prefix portion 540 to produce millimeter. In the embodiment of FIG. 5A a single symbol table 440 can include symbol portion 510, operator portion 520, unit portion 530, and unit prefix portion 540. In other embodiments, symbol table 440 can be configured in other ways.

For example, FIG. 5B illustrates an embodiment that can include a symbol table that can be distributed among tables 560, 570 and 580. For example, table 560 may be a first data structure that stores a symbol table that contains symbol portion 510. Table 570 may be a data structure that stores operator portion 520, and table 580 may be a data structure that includes unit portion 530 and unit prefix portion 540. In an alternative embodiment of table 580 (not shown), entries from unit prefix portion 540 can be stored in unit portion 530 with the units that prefixes operate with.

Other embodiments of system 100 can include one or more symbol tables that interact with software objects to store information for model 145. For example, symbol table 560 may store a symbol, such as A, where A is related to an object that stores information related to A, such as a value, unit information, a context identifier, a model identifier, annotations that describe constraints (i.e., a constant), metadata, etc.

### Exemplary Symbol Table and Software Object Interaction

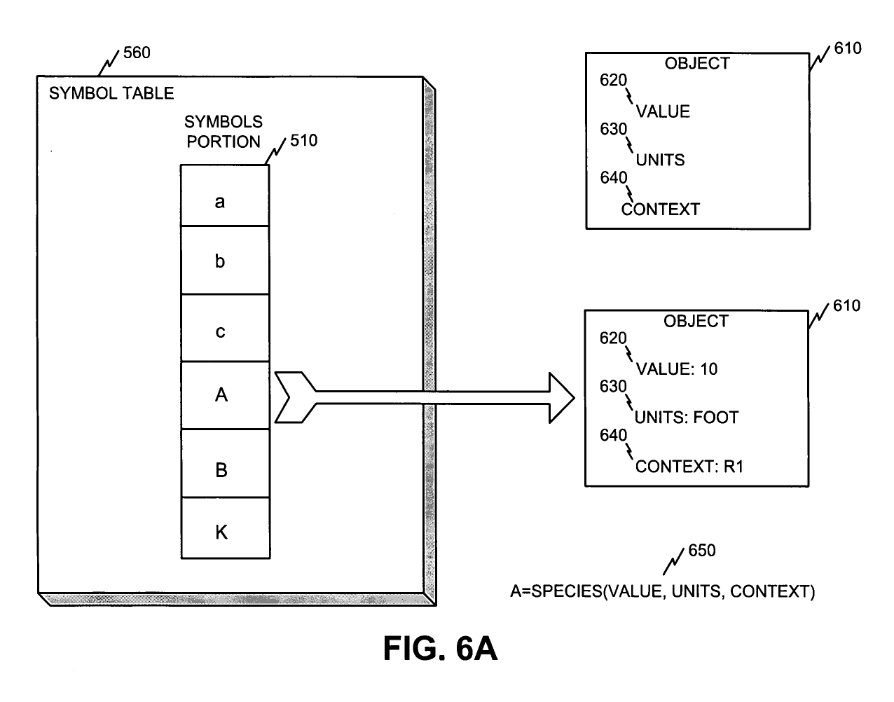

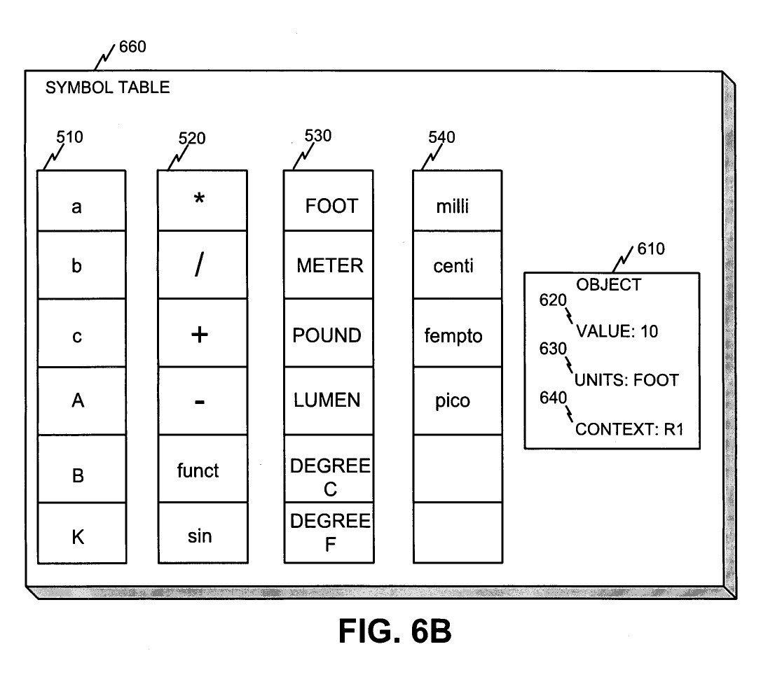

FIG. 6A illustrates symbol table 560 and a software object 610. Symbol table 560 may store symbol portion 510 for model 145. Symbols in symbol portion 510 may be associated with one or more software objects, such as object 610. In the embodiment of FIG. 6A, object 610 may hold a value 620, units 630 and context 640. Object 610 may be populated by a user of system 100 or by a device, such as a remote device or a processing device operating in system 100.

Assume that a user may interact with an editor of modeling environment 140 and may enter an expression that associates a symbol in symbol portion 510 with object 610. For example, the user may enter an expression of the form:

A=species (Value, Units, Context) Eq. 1.

Here, Eq. 1 may populate a software object with a value, a unit, and a context. Still referring to FIG. 6A, the user may enter

A=species (10, foot, R1) Eq. 2

Eq. 2 may associate a value of 10, units of foot and a context R1 with symbol A in model 145. Object 610 may be used in model 145 once the object is populated. Exemplary embodiments may let a user form objects for some or all of the symbols in symbol table 560.

In FIG. 6A, object 610 is stored separately with respect to symbol portion 510; however, object 610 may be stored with symbols portion 510 and/or other information, such as operator portion 570, unit portion 530, and/or prefix portion 540 (see FIG. 6B) is desired.

### Exemplary Rule Table

In an embodiment of system 100, symbol tables may interact with data structures that contain information that facilitates dimensional analysis. For example, a symbol table can interact with one or more rules that identify a sequence of acts that can be performed when system 100 attempts to auto-complete an entry on behalf of a user.

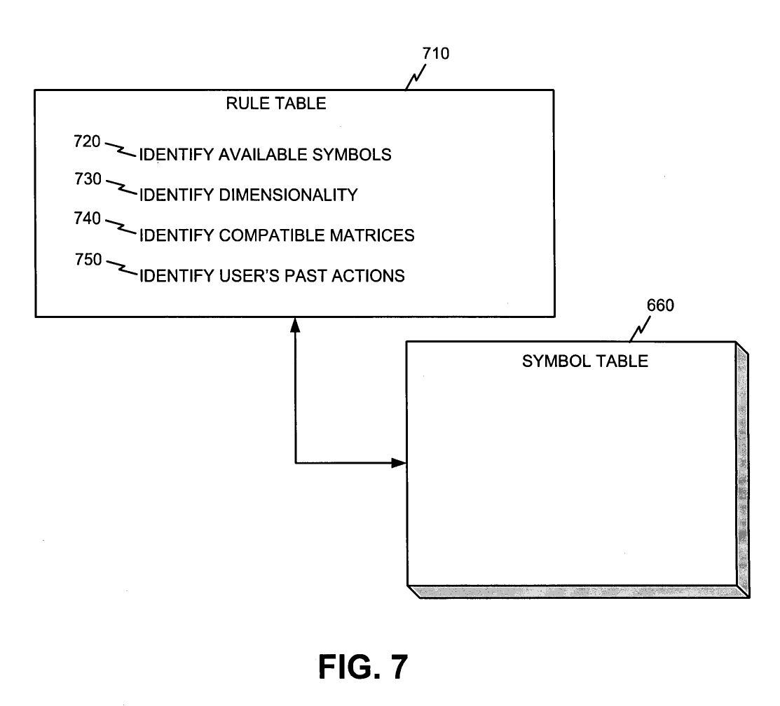

FIG. 7 illustrates a rule table 710 that can interact with symbol table 660 to auto-complete entries in system 100. An embodiment of system 100 may include a hierarchy of rules that are queried in a determined order to identify symbols that can be used to auto-complete user entries. This hierarchy may operate to reduce the number of possible entries as the rules are traversed. For example, a symbol table may store ten entries. When a first rule is applied the ten entries may be reduced to eight, e.g., by looking at a context. When a second rule is applied, the eight entries may be reduced to four, e.g., by evaluating units. Other rules may further reduce the number of possible entries.

Rules may further be applied to information using distributed processing logic. For example, referring to the example immediately above, the first rule may be applied to all ten stored entries and the second rule may also be applied to all ten entries. The first rule may be applied to the ten entries using a first processor and the second rule may be applied to the ten entries using a second processor. Results for the first rule and results for the second rule may be compared to identify common entries. These common entries can be passed to another rule for further processing, or the common entries can be displayed to a user as valid auto-complete entries.

Referring to FIG. 7, an embodiment may determine that available symbols should be identified before attempting to auto-complete a current user entry (rule 720). The embodiment may then determine that the dimensionality of the current entry should be evaluated to determine, for example, units that are appropriate to auto-complete the current entry (rule 730).

In certain situations one or more appropriate symbols may be identified when rules 720 and 730 are queried with respect to a current user entry. In these situations, one or more symbols may be displayed to the user and the user may select one of the symbols to auto-complete the current entry. In other situations, system 100 may evaluate additional or different rules before presenting one or more symbols to the user.

For example, system 100 may determine that the user is working with matrices where elements in the matrices include symbols having units. System 100 may determine that compatible matrices need to be identified before auto-complete entries can be suggested to the user (rule 740). For example, system 100 may determine that the user desires to multiply two matrices together. System 100 may evaluate rule 740 which may cause system 100 to select only matrices having proper dimensions (e.g., having diagonals that are the same length as the diagonal for a matrix entered by the user). Matrices having the proper dimensions and units may be displayed to the user for use as auto-complete entries.

In another situation, system 100 may evaluate a rule that indicates that a user's past actions with model 145 should be used to filter possible auto-complete entries (rule 750). For example, a user may work with symbols having a particular type of units or other type of characteristic. System 100 may maintain a history of the user's past interactions with model 145 and/or other models. System 100 may use the history to suggest auto-complete entries that should be acceptable to the user based on the user's past interactions with model 145 or the other model.

For example, system 100 may determine that ten auto-complete entries may work for a current entry based on evaluating rule 720 and 730 (i.e., availability of symbols and appropriate dimensionality). System 100 may filter the ten entries based on a user's past activities and may determine that two of the ten entries are most likely to be ones that the user will select. System 100 may order the ten entries such that the two most likely entries are at the top of an ordered list that includes the ten entries. System 100 may then display the ordered list to the user so that the user can select an auto-complete entry.

### Exemplary Auto-Complete Technique

Embodiments may display auto-complete entries to a user in a number of ways.

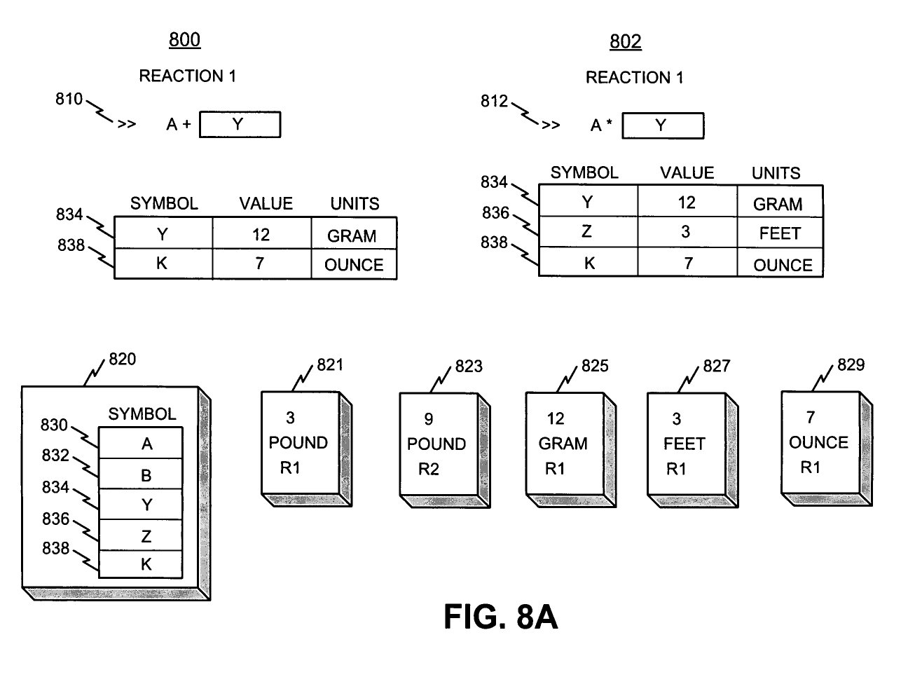

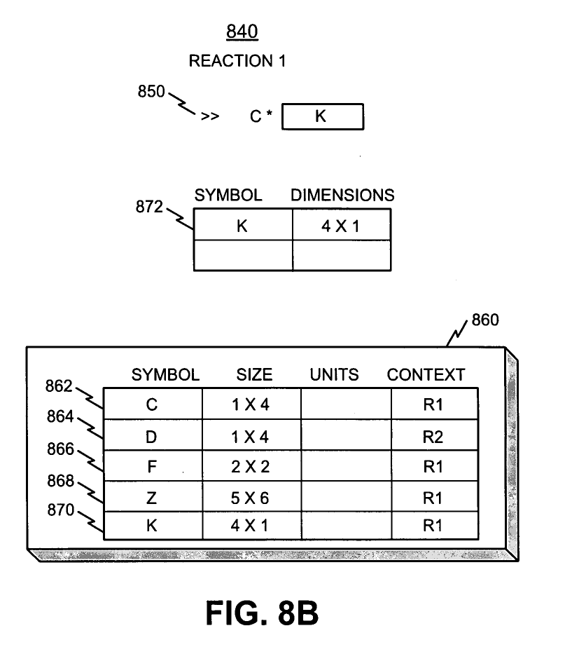

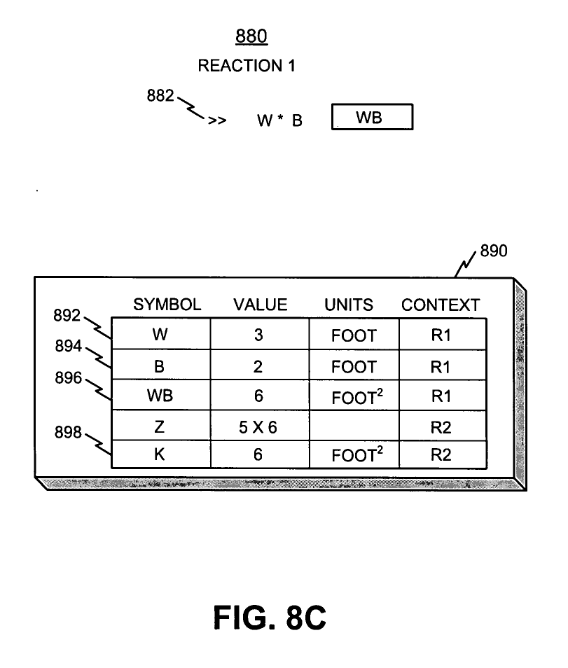

Referring to FIG. 8A, a user may interact with model 145 as shown in arrangement 800 and arrangement 802. In FIG. 8A, symbol table 820 may include entries 830, 832, 834, 836, and 838 that are, respectively, associated with objects 821, 823, 825, 827, and 829. In FIG. 8A, the objects can store values, units, and contexts for symbols stored in symbol table 820.

Referring to arrangement 800 in FIG. 8A, a user may enter an expression for reaction 1 via prompt 810. For example, the user may enter

A+

System 100 may interact with symbol table 820 and may identify A at entry 830 in symbol table 820. System 100 may further identify object 821 that contains a value of 3, units of pound, and a context of R1. System 100 may determine that the user is interacting with context R1 based on the information entered by the user. Since system 100 knows that the user is interacting with context R1, system 100 may use rule 720 to determine that available symbols for the expression are included only in context R1. System 100 may therefore exclude entry 832 and/or object 823 in symbol table 820 since they are associated with a context that differs from context R1, namely context R2.

System 100 may identify a dimensionality for A + using rule 730. Based on rule 730, system 100 may determine that entries 834 and 838 are appropriate for the expression since a valid expression needs to have symbols that are associated with context R1 and that have units of mass (e.g., a weight).

System 100 may display entries 834 and 838 proximate to prompt 810. System 100 may further identify an insertion location for auto-complete information (e.g., symbol Y or K) that is proximate to the portion of the expression that was entered by the user. For example, system 100 may display a symbol, an image, a shape, a cursor, etc., to identify where Y or K will be inserted when the user chooses to auto-complete the expression.

Arrangement 802 in FIG. 8A illustrates an expression that includes a multiplication operator. The user may enter

A*

at prompt 812. System 100 may use rule 720 and 730 to select entries 834, 836, and 838 as possible auto-complete entries for the expression. In arrangement 802 Y, Z, and K may be used in the expression since the multiplication operator can be used with symbols in context R1 that have units other than length. System 100 may arrange possible auto-complete entries in an ordered list and may display one of the auto-complete entries in the expression that the user is working with. The user may depress a key, such as a tab key, to insert the displayed entry into the expression. Alternatively, the user may depress a different key, such as an up arrow key, to replace the displayed auto-complete entry with a different auto-complete entry from the ordered list. If the user is satisfied with the second entry, the user can depress the tab key to insert that entry into the expression.

FIG. 8B illustrates an embodiment that may auto-complete expressions that include matrices (e.g., an array). For example, arrangement 840 may be associated with reaction 1 in model 145 and a user may enter

C*

at prompt 850. Symbol table 860 may include entry 862 that contains symbol C and other information associated with symbol C. For example, symbol table 860 may include size information that indicates that C is a 1×4 array, unit information that can identify units for values in the array, and/or context information for symbol C.

Other embodiments of symbol table 860 can include other types of information, such as separate entries for values residing in locations of the arrays, index information for the values in the array, etc. Other embodiments of symbol table 860 may further be configured in still other ways. For example, symbol table 860 may store symbols only and size information, values, units, contexts, etc., may be stored elsewhere, such as in objects.

In FIG. 8B, system 100 may evaluate rule 720 and rule 730 to identify symbol C, operator * and the dimensionality of the expression that includes C and *. System 100 may then use rule 740 to identify arrays that are compatible with the expression in arrangement 840. For example, system 100 may identify arrays that do not violate the dimensionality of the expression when an entry from symbol table 860 is inserted into the expression.

System 100 may determine that a 1×4 array (C) must be multiplied with an array that has a diagonal that matches the diagonal of array C (namely a diagonal of length 1). System 100 may determine that entry 870 (symbol K) can be used to complete the expression without violating dimensionality requirements. System 100 may display entry 870 proximate to the expression via table 872. The user can depress a key, such as the tab key, to auto-complete the expression by inserting K into an identified location within the expression. In an alternative embodiment, system 100 can display K in the expression, and the user can depress a key to insert the auto-complete entry at its current position within the expression.

In FIG. 8C, system 100 can perform auto-complete operations that allow information in an expression to be expressed in a consolidated form. For example, a user may enter

W*B

at prompt 882 in arrangement 880.

System 100 may determine that W and B are symbols included in symbol table 890 (see entry 892 and 894). System 100 may further identify that a consolidated form of the expression W*B is already known to system 100. For example, a symbol WB may be defined in symbol table where WB is associated with information that matches a result produced by W*B.

When the user enters W*B, system 100 may display WB proximate to the expression and the user may depress a key to select the consolidate representation WB. When the user selects WB, the expression W*B may be replaced with WB via an auto-complete operation. System 100 may streamline the way information is displayed in expression by consolidating expressions for the user.

### Exemplary Functional Diagram

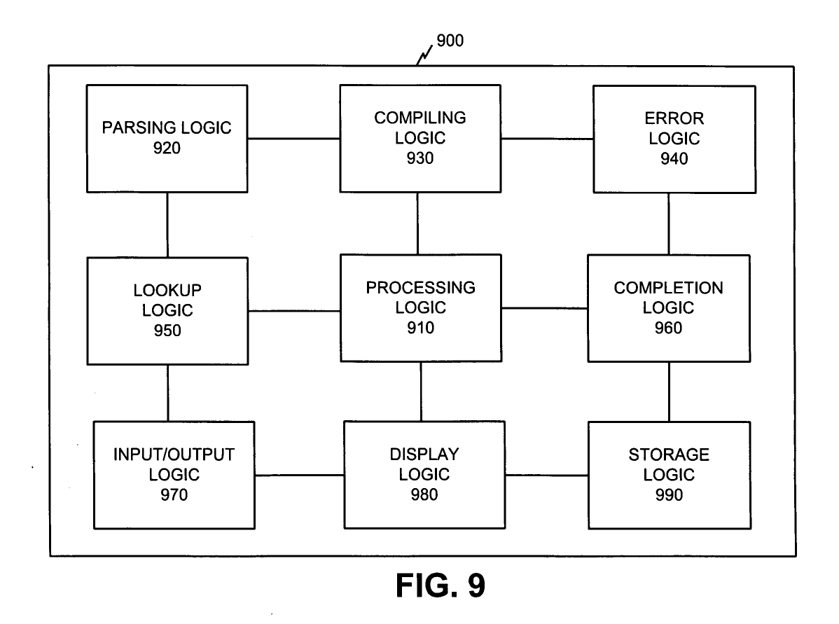

FIG. 9 illustrates an exemplary functional diagram. Functional diagram 900 can include processing logic 910, parsing logic 920, compiling logic 930, error logic 940, lookup logic 950, completion logic 960, input/output logic 970, display logic 980 and storage logic 990. Logic in FIG. 9 can reside on a single device, such as system 100, or the logic can be distributed across multiple devices. Moreover, the logic of FIG. 9 can be implemented in hardware based logic, software based logic, and/or a combination of hardware and software based logic (e.g., hybrid logic, wetware, etc.). The implementation of FIG. 9 is illustrative, and computer system 100 and/or other devices may include more or fewer functional components without departing from the spirit of the invention.

Processing logic 910 may process instructions or data in system 100. Processing logic 910 may be implemented in a single device that can include one or more cores, or processing logic 910 may be implemented in a number of devices that can be local with respect to each other or remote with respect to each other (e.g., distributed over a network).

Parsing logic 920 may separate information into portions. For example, parsing logic 920 may operate in parser 150 and may examine information entered by a user to determine when the information is sufficient to constitute a meaningful portion. For example, a data structure in storage 190 may contain the information var_1=3 and var_2=12. A user may be entering information for a variable and parsing logic 920 may detect v, a, r, and _ without determining that a meaningful portion has been entered because two variables are known that include “var_” in their names.

The user may then enter “7” and parsing logic 920 may determine that “var_7” is not yet defined. Parsing logic 920 may indicate an error and may send the indication to a destination, such as another piece of logic in system 100 (e.g., to display logic 980). In an embodiment, parsing logic 920 can check for dependencies associated with entered information to facilitate efficient error propagation (e.g., propagating errors to a user). Embodiments of parsing logic 920 may further detect collisions between information associated with model 145.

Compiling logic 930 may convert an input from a first representation into a second representation. For example, compiling logic 930 may receive information from parsing logic 920 in a first format that is associated with a user input. Compiling logic 930 may compile the information and may produce a second format that can be used to perform a simulation (e.g., by executing a model). Compiling logic 930 may be adapted to run when modeling environment 140 is open so as to maintain model 145 in a compiled state while a user interacts with model 145. In an embodiment, compiling logic 930 may generate a stoichiometry matrix of relationships for reactants and products used in reactions or equations, such as chemical reactions or equations, in model 145.

Error logic 940 may generate an error message using information received from a device or piece of logic, such as parser 920 and/or compiling logic 930. For example, error logic 940 may report errors from a mathematical standpoint for inputs entered by a user of system 100. Error logic 940 may further suggest solutions that can correct the error. For example, referring to the example above, parsing logic 920 may send information to error logic 940 when it detects “var_7” and error logic 940 may generate a message “var_7 is not yet defined.”

In an embodiment, error logic 940 may operate with other logic in system 100 to generate a symbol, e.g., a variable name, and may associate information with the generated symbol that is correct with respect to rules in rule table 710. Referring to the example immediately above, error logic 940 may generate a symbol var_7 and may attempt to associate unit information, context information, unit prefix information, size information (e.g., matrix dimensions), etc., with the generated symbol. In this example, error logic 940 may not be able to fill in a value, e.g., a numerical value; however, a user will have a dimensionally consistent and/or correct framework in which to insert a value for var_7.

Lookup logic 950 may retrieve information from a data structure, such as a symbol table, and may make the retrieved information available to a destination, such as display 110. Other embodiments of lookup logic 950 may use other types of data structures, such as lookup tables, lists, databases, etc. In fact, lookup logic 950 may employ substantially any technique that accepts a key and retrieves a corresponding piece of information (e.g., a value, a name, etc.) based on the key.

Completion logic 960 may provide auto-complete entries to a user via display logic 980. For example, completion logic 960 may receive a list of possible auto-complete entries from lookup logic 950 when parsing logic 920 generates an output based on information entered by a user. In one embodiment, completion logic 960 may display a single auto-complete entry to a user. In another embodiment, completion logic 960 may display an ordered list of auto-complete entries to the user, where the ordering in the list is determined using rules from rule table 710, user preferences, system preferences, etc. Auto-complete entries produced by completion logic 960 may complete a portion of an expression or may complete an entire expression for a model.

Input/output logic 970 may receive information from a user, another device, and/or another piece of logic and may send information to another device or piece of logic. For example, input/output logic 970 may include a network interface card (NIC) that receives information from a remote database. Input/output logic 970 may further include a graphics card that is used to display the retrieved information to a user via display 110. Input/output logic 970 may include other devices, such as printers, wireless transceivers, etc.

Display logic 980 may display information to a user. In one embodiment, display logic 980 may include display 110. Display logic 980 can further include logic to provide the user with information via non-visual notification techniques. For example, display logic 980 may notify a user via sound from a speaker, a tactile output device, etc., without departing from the spirit of the invention.

Storage logic 990 may store information locally or remotely for model 145 using one or more storage devices, such as magnetic and/or optical storage devices.

### Exemplary Processing

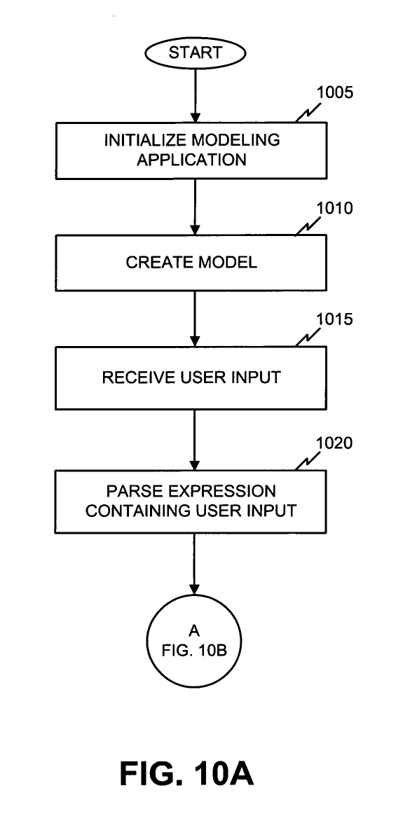

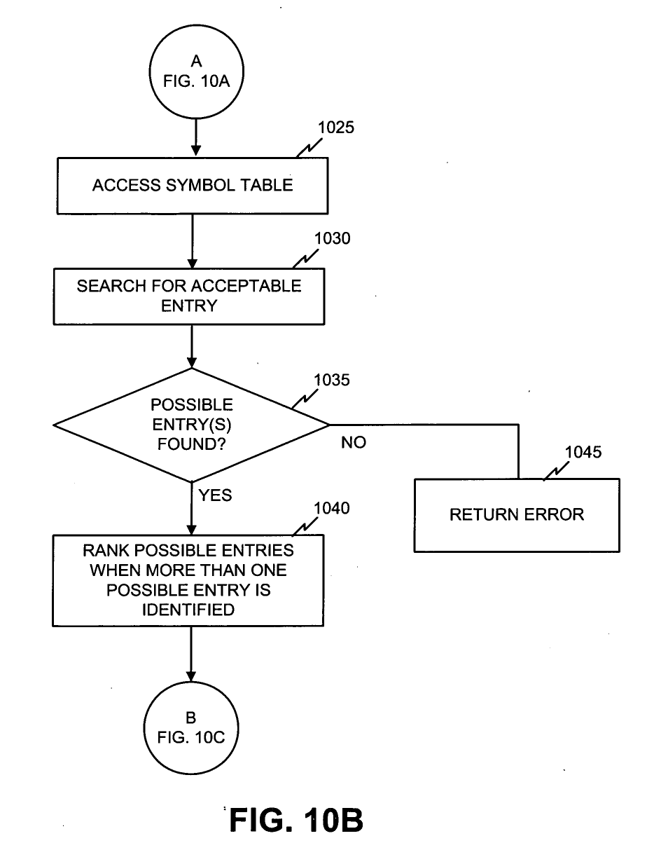

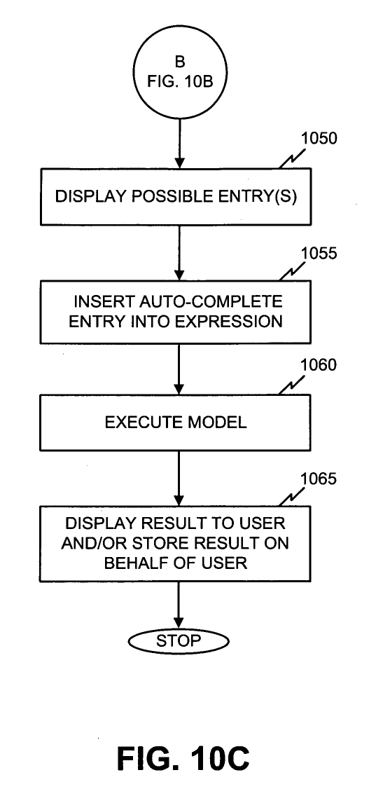

FIGS. 10A-10C illustrate exemplary processing for performing a simulation using one or more auto-completed entries. A modeling application may be initialized (act 1005). For example, a user may select an icon that is associated with a graphical modeling application that can perform simulations for biological systems. The user may make a selection to create a model (act 1010). For example, a user may make a selection that allows the user to create a new model, edit an existing model, etc. In one embodiment, the user may be presented with a graphical user interface (GUI) when the model is created and the user may interact with the model using the GUI.

A user input may be received by the model (act 1015). In one embodiment, the user may enter symbols, operators, numbers, etc., via a text based GUI. In another embodiment, the user may drag and drop symbols, icons, text, numbers, etc., using a pointing device, such as a mouse. In still other embodiments, the user may provide inputs to the model via speech and/or other techniques. For example, a user may drag a species icon from a library into model 145. The user may enter information about the species via an input device, such as a keyboard. For example, the user may give the species a name, a scope, an initial amount, units for the initial amount, etc.

Parsing logic 920 may parse the information entered by the user (act 1020). For example, parsing logic 920 may interpret symbols, numerical values, operators, etc., entered by the user. In one embodiment, parsing logic 920 may be implemented in parser 150 and may parse user entries in substantially real-time, e.g., while the user is entering information into model 145.

By way of example, a user may enter A and the operator +. Parsing logic 920 may parse A and + and may pass a parsing result to other logic in system 100. In one embodiment, parsing logic 920 can pass a parsing result to completion logic 960, where completion logic 960 can interact with lookup logic 950 to interact with one or more symbol tables and/or software objects.

Referring now to FIG. 10B, lookup logic 950 may access a symbol table, such as symbol table 820 (act 1025). Continuing with the example, lookup logic 950 may access symbol table 820 and may provide information about the contents of the symbol table to completion logic 960. Completion logic 960 may use the received information to determine what value, units and context are associated with A and/or the operator +. For example, symbol table 820 may return A (entry 830) and a link to an object, such as object 821. The object may include a value, units and context information for the symbol A.

Information associated with A (e.g., value, units, and context) may be used with the operator + to search for acceptable auto-complete entries (act 1030). Continuing with the example, a model may include contexts R1, R2, and R3. Completion logic 960 may use dimensional analysis and/or other techniques to determine which symbols can be used for auto-complete entries. In the example, the completion logic 960 may determine that symbol table entries associated with contexts R2 or R3 are not possible auto-complete entries since the user is working in context R1. Entry 832 may be excluded since it is associated with context R2. Completion logic 960 may further evaluate remaining symbol table entries to identify ones that can be used to auto-complete the expression that the user is entering into model 145.

Further continuing with the example, dimensional analysis may further exclude entry 836 (Z) since Z has units of feet and A has units of pound. In the example, the expression includes an addition operator + so units of pounds are not compatible with units of feet in the expression. In one embodiment, A may be excluded as a possible auto-complete entry when an expression is not allowed to include the same symbol twice. For purposes of the example, we can assume that A can only be used once in the expression.

Completion logic 960 may iterate until it determines whether possible auto-complete entries exist in symbol table 820 (act 1035). Error logic 940 may return an error when completion logic 960 determines that no auto-complete entries are present in symbol table 820 (act 1045). In another embodiment, error logic 940 may not return an error when no auto-complete entries are present in symbol table 820. In this embodiment, system 100 may not show any possible auto-complete entries to the user when no possible auto-complete entries are in symbol table 820. In still another embodiment, error logic 940 may generate a new symbol and may augment the symbol with available information (e.g., context, units, dimensions, etc.) to assist a user with generating a complete expression for the model.

Completion logic 960 may rank possible auto-complete entries when more than one possible entry is found in a symbol table (act 1040). Continuing with the example, completion logic 960 may determine that symbol table 820 includes two entries that are possible auto-complete entries for the expression entered by the user. In the example, entry 834 (Y) and entry 838 (K) may be identified as possible auto-complete entries. Completion logic 960 may rank entry 834 and 838 using a determined criteria. For example, completion logic 960 can use past operations performed by the user, additional information in context R1 and/or other parts of model 145, etc., to order the possible auto-complete entries for the user.

Referring now to FIG. 10C, system 100 may display possible auto-complete entries to the user via display logic 980 (act 1050). Continuing with the example, entry 834 and entry 838 may be displayed to the user according to the determined ordering. In one embodiment, entries 834 and 838 may be displayed proximate to the expression that the user is working with. In another embodiment, the entry identified as the most likely one to satisfy the user may be inserted into the expression at an appropriate location.

System 100 may insert one of the auto-complete entries into the expression (act 1055). Continuing with the example, the user may drag one of the ordered entries from a location proximate to the expression and may place the dragged entry into the expression at a determined location. Alternatively, the user may depress a key to select an auto-complete entry that is displayed in the expression. For example, when completion logic 960 displays a most likely one of the ordered entries in the expression, the user may need to perform an action to insert the entry into the expression. Depressing a key on a keyboard may be an acceptable action to insert the entry into the expression.

The model may be executed using the expression that includes the auto-complete entry (act 1060). Continuing with the example, the user may select a “run model” icon using a pointing device to execute model 145. Alternatively, model 145 may automatically execute when a complete expression is detected. Model 145 may produce one or more results when execution completes. The one or more results may be displayed to the user and/or may be stored in storage logic 990 (act 1065). Results generated by the model can include instructions to perform operations, plots showing performance predictions for a biological system, etc.

In an alternative embodiment, model 145 may generate code when the model is executed (act 1060). The generated code may include code that is used to complete the simulation of model 145. In one embodiment, generated code may be adapted to transmission to another device, where the generated code can be run on the other device when received thereon. Generated code may be in substantially any format (e.g., human-readable, machine-readable, etc.) and may be in substantially any programming language (e.g., C, C++, assembly language, M-langauge, etc.).

### Other Exemplary Embodiments

A first embodiment may implement modeling environment 140 in a technical computing environment (TCE). For example, the TCE may employ a dynamically typed language that uses an array as a basic data type. In an embodiment, the TCE can be a text-based TCE. Examples of text-based TCE's that can be used are, but are not limited to, MATLAB® software by The MathWorks, Inc.; Octave; Python; Comsol Script; MATRIXx from National Instruments; Mathematica from Wolfram Research, Inc.; Mathcad from Mathsoft Engineering & Education Inc.; Maple from Maplesoft; Extend from Imagine That Inc.; Scilab from The French Institution for Research in Computer Science and Control (INRIA); Virtuoso from Cadence; or Modelica or Dymola from Dynasim.

A second embodiment may implement a TCE in a graphically-based environment using products such as, but not limited to, Simulink® software, SimBiology® software, Stateflow® software, SimEvents™ software, etc., by The MathWorks, Inc.; VisSim by Visual Solutions; LabView® by National Instruments; Dymola by Dynasim; SoftWIRE by Measurement Computing; WiT by DALSA Coreco; VEE Pro or SystemVue by Agilent; Vision Program Manager from PPT Vision; Khoros from Khoral Research; Gedae by Gedae, Inc.; Scicos from (INRIA); Virtuoso from Cadence; Rational Rose from IBM; Rhopsody or Tau from Telelogic; Ptolemy from the University of California at Berkeley; or aspects of a Unified Modeling Language (UML) or SysML environment.

A third embodiment may be implemented in a language that is compatible with a product that includes a TCE, such as one or more of the above identified text-based or graphically-based TCE's. For example, MATLAB software (a text-based TCE) may use a first command to represent an array of data and a second command to transpose the array. Another product, that may or may not include a TCE, may be MATLAB-compatible and may be able to use the array command, the array transpose command, or other MATLAB commands. For example, the other product may use the MATLAB commands to perform optimizations on one or more units of execution.

Still other embodiments/implementations are possible consistent with the spirit of the invention.

Embodiments described herein produce useful and tangible results. For example, tangible results (e.g., results that can be perceived by a human) can be produced when a result is displayed to a user, when a device makes a sound, vibrates, performs an operation (e.g., moves, interacts with a person, etc.), etc. Useful results may include, but are not limited to, storage operations, transmission operations (e.g., sending information or receiving information), display operations, displacement operations, etc. Tangible and/or useful results may include still other activities, operations, etc., without departing from the spirit of the invention.

### CONCLUSION

Implementations may provide a modeling environment that allows a user to model a biological system without having to manually complete expressions when dimensionally compatible information is known to the model.

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, while a series of acts has been described with regard to FIG. 10A-10C, the order of the acts may be modified in other implementations consistent with the principles of the invention. Further, non-dependent acts may be performed in parallel.

In addition, implementations consistent with principles of the invention can be implemented using devices and configurations other than those illustrated in the figures and described in the specification without departing from the spirit of the invention. Devices and/or components may be added and/or removed from the implementations of FIGS. 1 and 9 depending on specific deployments and/or applications. Further, disclosed implementations may not be limited to any specific combination of hardware.

Further, certain portions of the invention may be implemented as “logic” that performs one or more functions. This logic may include hardware, such as hardwired logic, an application-specific integrated circuit, a field programmable gate array, a microprocessor, software, wetware, or a combination of hardware and software.

No element, act, or instruction used in the description of the invention should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

Headings and sub-headings used herein are to aid the reader by dividing the specification into subsections. These headings and sub-headings are not to be construed as limiting the scope of the invention or as defining the invention.

The scope of the invention is defined by the claims and their equivalents.

What is claimed is:

1. One or more computer-readable media storing instructions executable by processing logic, the media storing one or more instructions for:
processing an expression for use as an input to a life sciences model, the expression including one or more symbols and one or more operators;
interacting with a data structure that includes a plurality of symbols with at least one of the plurality of symbols related to a software object that includes a value, a context, or unit information;
identifying the at least one symbol as a compatible symbol that is compatible with the expression;
displaying the compatible symbol proximate to the expression;
receiving a user input that indicates that the compatible symbol should be inserted into the expression at a predetermined location;
inserting the compatible symbol into the expression proximate to the predetermined location;
executing the life sciences model using the expression when the expression includes the compatible symbol; and
generating a result for the life sciences model based on the executing.

2. The one or more computer-readable media of claim 1, where the one or more instructions for identifying includes querying a rule table.

3. The one or more computer-readable media of claim 1, where the life sciences model includes a plurality of contexts, the context included in the plurality of contexts.

4. The one or more computer-readable media of claim 3, where the context is associated with a first location in the life sciences model and another of the plurality of contexts is associated with a second location in the life sciences model.

5. The one or more computer-readable media of claim 4, where the compatible symbol is associated with the first location, the media further storing one or more instructions for:
moving the compatible symbol from the first location to the second location; and
associating the software object with the second location.

6. The one or more computer-readable media of claim 1, where the identifying further comprises:
one or more instructions for performing dimensional analysis on the expression.

7. The one or more computer-readable media of claim 1, where the identifying is performed prior to compiling the life sciences model.

8. The one or more computer-readable media of claim 1, where the life sciences model is implemented in a dynamically typed programming language.

9. The one or more computer-readable media of claim 1, where the context is represented using a syntax that includes a semicolon or another symbol.

10. The one or more computer-readable media of claim 1, where the context is one of a plurality of contexts arranged in a hierarchy.

11. The one or more computer-readable media of claim 1, where the data structure is a symbol table.

12. A computer-implemented method, comprising:
interacting with a life sciences model using at least:
a first symbol,
an operator,
the first symbol and the operator,
the first symbol and a second symbol, or
the first symbol, the second symbol, and the operator;
displaying a compatible symbol proximate to an executable expression that includes the first symbol, the second symbol or the operator, the compatible symbol retrieved from a data structure that stores the compatible symbol and a plurality of other symbols, the compatible symbol associated with a software object that includes at least one of a value, a context, or unit information for the compatible symbol;
selecting the compatible symbol, the selecting inserting the compatible symbol at a predetermined location in the expression;
executing the expression using the life sciences model; and
generating a result based on the executing.

13. The computer-implemented method of claim 12, further comprising:
displaying a list of compatible symbols, the list including the compatible symbol and other symbols that are compatible with the expression.

14. The computer-implemented method of claim 12, further comprising:
displaying the context in the life sciences model; and
displaying a second context in the life sciences model.

15. The computer-implemented method of claim 12, where the software object is stored in the data structure.

16. One or more computer-readable media storing instructions executable on processing logic, the medium storing:
one or more instructions for receiving a first user input associated with a context;
one or more instructions for querying a symbol table comprising a plurality of symbols and a plurality of operators, the plurality of symbols including a compatible symbol and the plurality of operators including a compatible operator;
one or more instructions for interacting with a rule, the rule used to identify the compatible symbol included in the plurality of symbols or the compatible operator included in the plurality of operators, the compatible symbol associated with a software object that includes information for use within the context; and
one or more instructions for inserting the compatible symbol or the compatible operator into an executable expression that includes the user input, the inserting based on a second user input configured to associate the compatible symbol or the compatible operator with the executable expression, the executable expression producing a result when executed in a model.

17. The one or more computer-readable media of claim 16, where the second user input is produced when a keyboard key is depressed, a mouse movement occurs, a user movement occurs, or an utterance is detected.

18. The one or more computer-readable media of claim 16, where the one or more instructions for interacting include:
performing dimensional analysis to identify the compatible symbol or the compatible operator.

19. A system comprising:
storage logic to:
store a data structure comprising:
an identifier,
store an object associated with the identifier, the object
comprising:
a value,
unit information, or
a context, and
store a result; and
processing logic to:
process an expression to determine whether the identifier is compatible with the expression, the determining performed using the value, the unit information, or the context,
insert the identifier into the expression when the identifier is
compatible with the expression, the inserting based on a user action,
execute the expression on behalf of a life sciences model,
generate the result based on the executing, and
provide the result to the storage logic.
